(19) United States
(12) Patent Application Publication
(10) Pub. No.: US 2007/0159689 A1
(43) Pub. Date: Jul. 12, 2007

(54) Tube-type revolver with at least four positions for injecting or extracting light into or from a laser scanning microscope

(76) Inventors: Dieter Schau, Lehesten (DE); Peter Huehn, Jena (DE); Michael Goelles, Jena (DE); Joerg-Michael Funk, Jena (DE)

Correspondence Address: JACOBSON HOLMAN PLLC, 400 SEVENTH STREET N.W., SUITE 600, WASHINGTON, DC, 20004, US

(21) Appl. No.: 10/586,137

(22) PCT Filed: Mar. 24, 2005
(86) PCT No.: PCT/EP05/03147

§ 371 Date: Jul. 17, 2006

(30) Foreign Application Priority Data
Mar. 31, 2004 (DE) 10 2004 016 433.9

(51) Int. Cl. G02B 21/00

(52) U.S. Cl. 359/384

(57) ABSTRACT

Arrangement for changing the uncoupling of the object beam and/or the coupling of the beam in a Laser Scanning Microscope, whereby a rotatable tube revolver is provided, which has at least four switching positions and each tube position is associated with a separate tube lens as well as deflecting elements for the object beam, whereby the tube positions for at least the LSM operation, LSM/NDD and/or manipulation and/or illumination, camera and visual operation modes are provided.

Practical combination of suitable methods is the key in the microscopy. Therefore, provision of various coupling points in microscopes is increasingly becoming a basic requirement in the research.

A number of interfaces for the illumination in the incident light and transmitted light techniques exist already, and are employed in the standard practice [DE 19702753 A1]. Installation of modern devices for manipulation, such as laser tweezers, or for the method of non-descanned detection in combination with the Laser Scanning Microscopy, place high demands on the device concept and the construction of the tubes, which, in addition to that, are required to enable the classical VIS observation or a camera recording with ease.

In particular, the construction of simple tubes with N alternatives for decoupling demands enormous space requirement, corresponding, to be specific, to 2N-1 prism widths. Therefore the conventional tubes are equipped with a maximum of three switching positions. The shifting of the prisms that are not required into a second dimension enables, with practical use of the combined sliding positions, further reduction of the required space [EP 0842449 B1].

### INVENTION

The object of the invention is to provide a space-saving tube with at least 4 output canals, of which one is provided for the visual observation, one for the camera, one for the Laser Scanning Microscope (LSM) and one canal for a method to be employed in combination with LSM, such as the NDD method, or for a manipulation beam or a second scan microscope or a pair of laser tweezers. The switching can optionally take place mechanically by means of a motor or manually.

According to the invention, it was found that the required space can be reduced to a plane, if the switching positions that are not used do not take additional space. They were therefore arranged on a ring. Combination with the switching positions in at least one more plane leads to a very compact switching unit.

A part of the optic required for the decoupling is situated on a tube lens revolver and deflects the light entering into the tube into the corresponding canals. This is achieved, for

the VIS output canal, through the joint rotation of the tube lens and the bauernfeind prism into the lower mirroring plane,

the photo output canal, through the joint rotation of the tube lens and a glass body, which is puttied together from a 90-degree prism and a suitable glass path,

the LSM output canal, through the joint rotation of at least one mirror and an LSM tube lens,

the NDD output canal, through the joint rotation of at least one beam splitter and an LSM tube lens

in the tube revolver.

Constituent features of the device are the commonly used variations as well as the reversal of the observation and recording beam paths known in the art.

### DETAILED DESCRIPTION

The rotatable tube revolver is driven by means of a motor M and a toothed drive belt R.

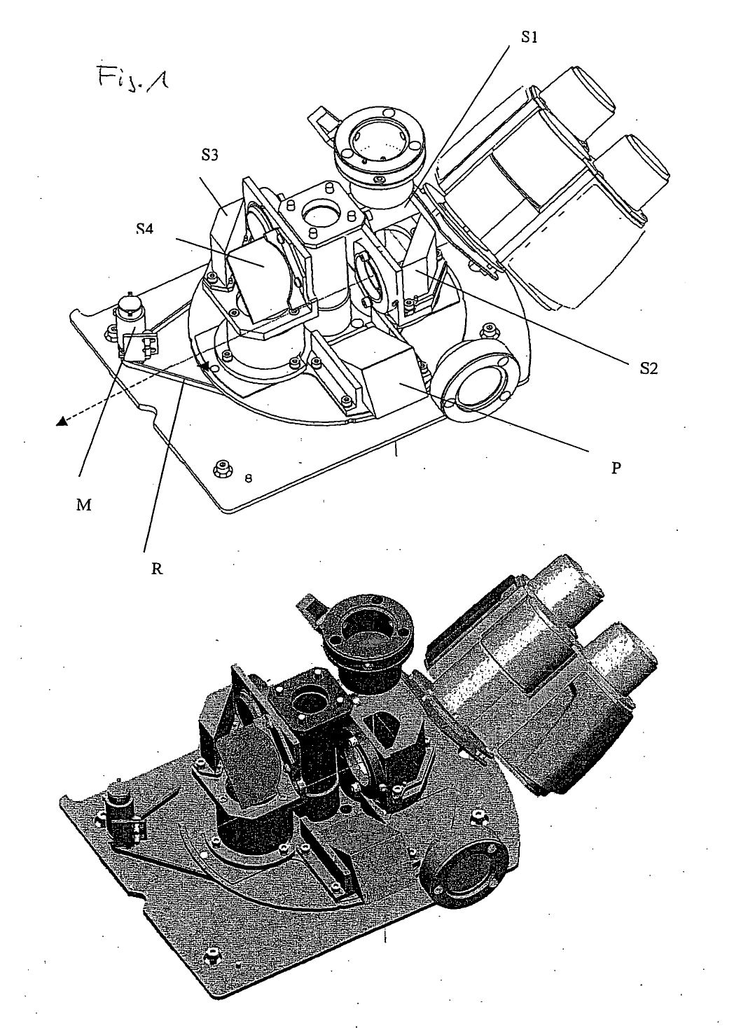

In FIG. 1 (position LSM), the beam coming from the object through the mirror S1, S2 is deflected at first laterally and then away from the eyepiece in the direction of the scanner of the LSM. Advantageous thereby is that the beam reaching the LSM assumes an eccentric position with respect to the axis of rotation of the tube revolver due to the lateral deflection by the mirror S1, so that despite the compact build, none of the elements necessary for the other output canals blocks the path.

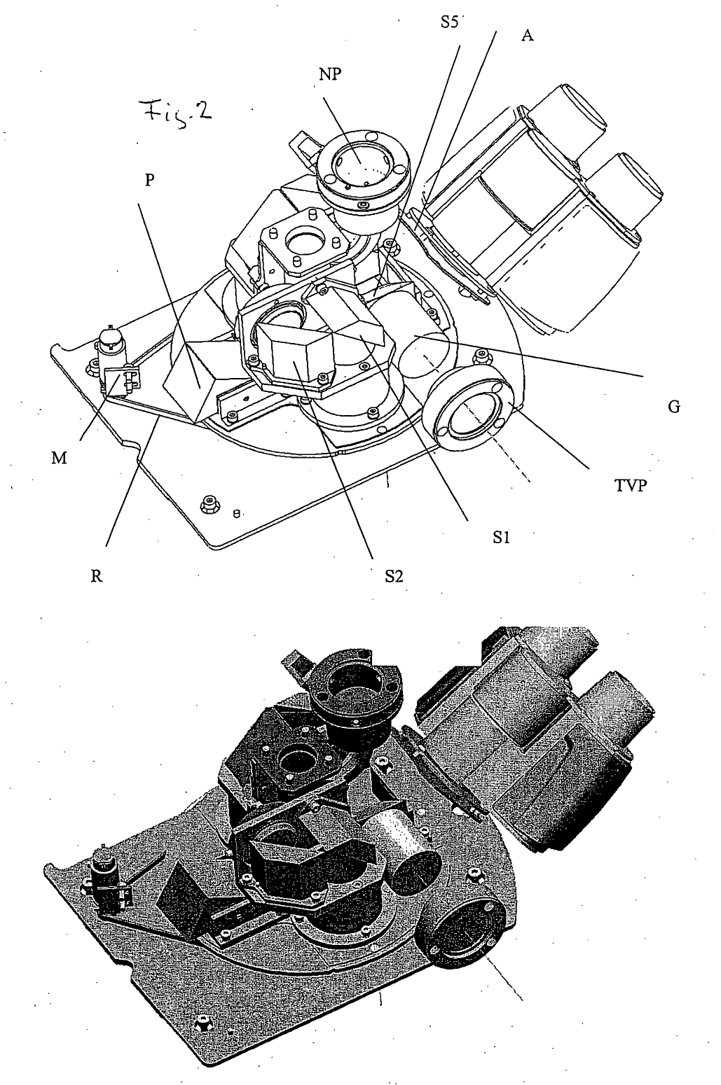

In FIG. 2 (position TV) is the tube revolver after rotation by 90 degrees. The light coming from the object is deflected through the mirror S5 and a glass element G to the path compensation on a TV port TVP on the side, which serves the purpose as a support for a camera for the recording of the image.

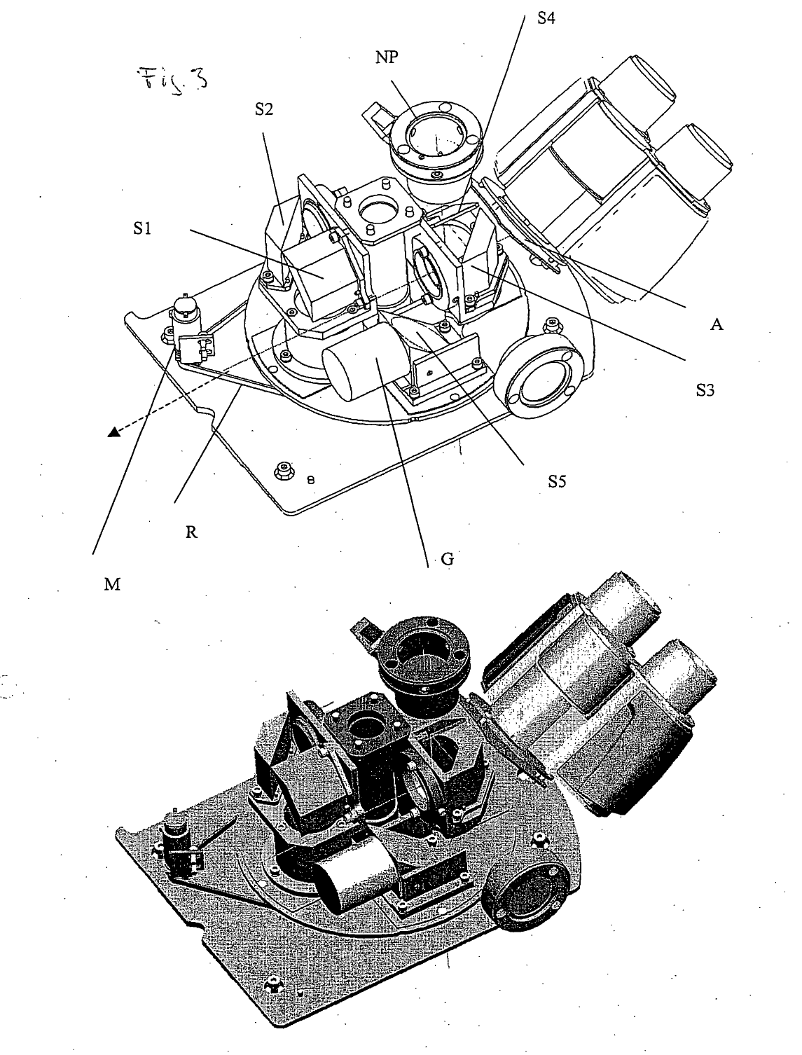

In FIG. 3 (position NDD), in a position of the tube revolver rotated by 90 degrees with respect to FIG. 2, non-descanned detection of the object beam passing through the beam splitter S4 upwards in the direction of an NDD port NP takes place, which is followed by a detection beam. Simultaneously, a part of the object beam is deflected by S4 laterally as in FIG. 1, and is deflected eccentrically by the mirror S3 in the direction of the LSM beam, so that both the descanned as well as the non-descanned detection take place at the same time. With the arrangement of the elements, with the LSM or NDD/LSM beam offset by 180 degrees, it is advantageously possible to realize lateral displacement of the LSM beam two times.

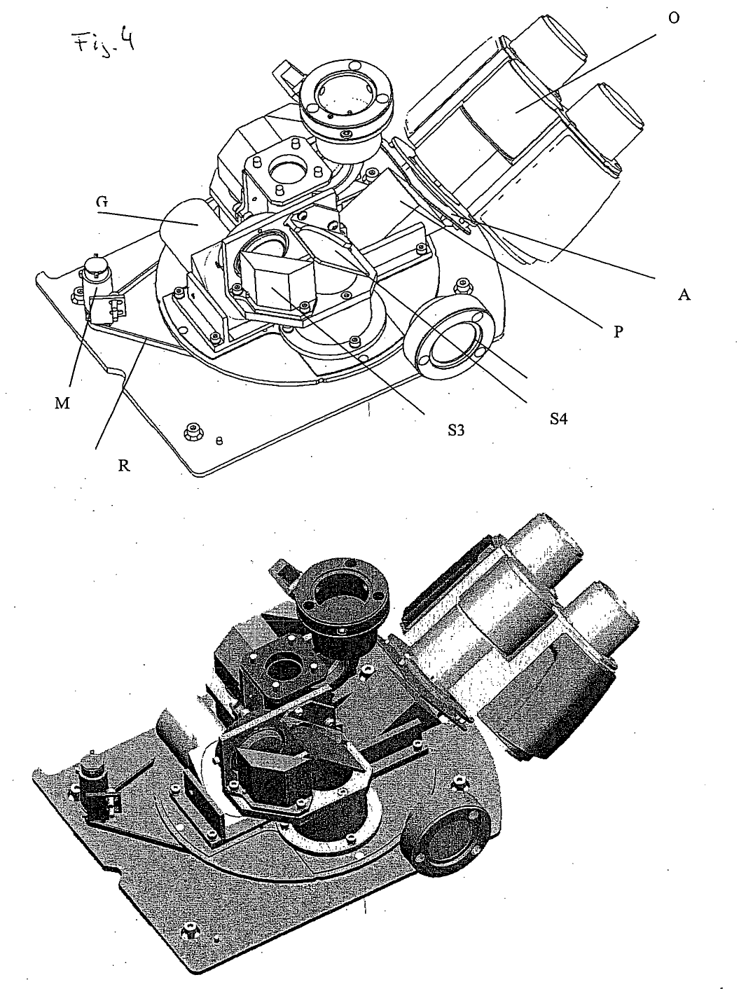

In FIG. 4 (position VIS), in tube revolver position that is rotated once again by 90 degrees, the deflection of the object light in the direction of the eyepiece O takes place by means of a ridge prism.

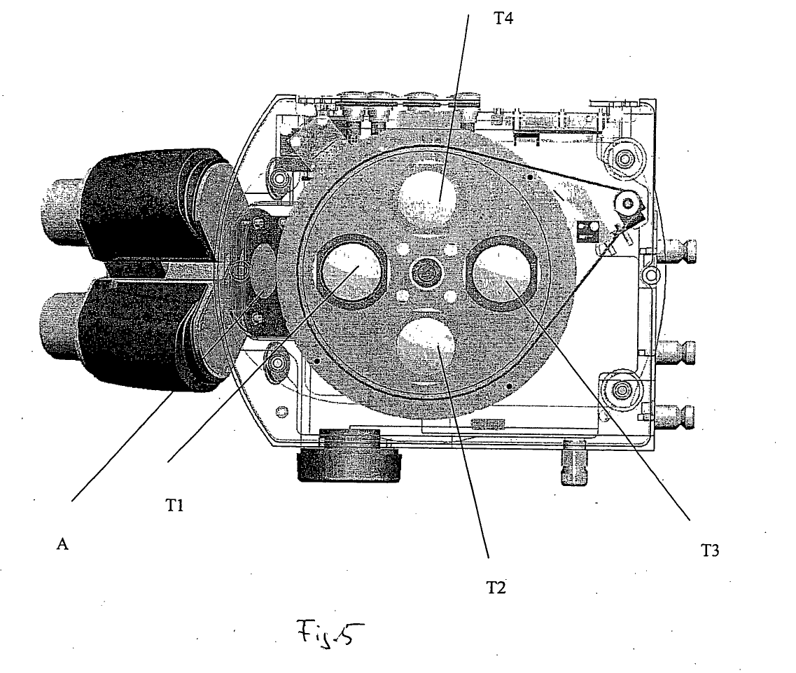

FIG. 5 shows the bottom view of the tube revolver with the tube lenses T1-T4, associated with the respective elements in FIG. 1-4, as well as a cover A, which is moved in the NDD mode like a shutter to keep the ambient light away.

Thus a separate tube lens is provided advantageously for each tube position, whereby the respective opposite tube lenses for the observation/recording or the LSM/LSM+NDD can be embodied optically the same manner.

Despite the numerous possibilities of switching within a very narrow space, the effort required for mechanical manipulation and the justification is very little in this arrangement, because the opposite locations of the tube lens and the deflecting elements are mutually fixed and do not require any justification.

1. Arrangement for changing the uncoupling of the object beam and/or the coupling of the beam in a Laser Scanning Microscope,
whereby a rotatable tube revolver is provided, which has at least four switching positions and each tube position is associated with a separate tube lens as well as deflecting elements for the object beam.

2. Arrangement according to claim 1, whereby at least the tube switching positions for the LSM operation, LSM/NDD and/or manipulation and/or illumination, camera and visual operation are provided.

3. Arrangement according to claim 1, whereby the tube positions for the LSM and LSM/NDD and/or manipulation and/or illumination lie mutually opposite on the revolver.

4. Arrangement according to claim 1, whereby for achieving eccentric uncoupling of the LSM beam, a lateral offset of the beam is generated.

5. Arrangement according to claim 4, whereby the uncoupling axis of the LSM beam path does not coincide with the axis of rotation of the tube revolver.

6. Arrangement according to claim 1, whereby the mutually opposite tube lenses are embodied optically in the same manner.

7. Arrangement according to claim 1, whereby a shutter for the VIS output canal is provided for the NDD and/or manipulation operation mode.
